(19) United States
(12) Patent Application Publication
(10) Pub. No.: US 2012/0216359 A1
(43) Pub. Date: Aug. 30, 2012

(54) Medical Implement Cleaning System

(75) Inventors: Bobby E. Rogers, San Diego, CA (US); Gino Kang, Irvine, CA (US)

(73) Assignee: Ivera Medical Corporation, San Diego, CA (US)

(21) Appl. No.: 13/398,736

(22) Filed: Feb. 16, 2012

Related U.S. Application Data
(60) Provisional application No. 61/444,629, filed on Feb. 18, 2011.

(51) Int. Cl. B08B 1/00

(52) U.S. Cl. 15/104.93

(57) ABSTRACT

A cleaning system for medical implements includes a number of cleaning caps attached to a substrate. Each cleaning cap can be selectively and individually removed from the substrate, which, prior to such removal, acts as a seal to the opening of each cap. Each cap includes an inner cavity accessible through the opening. The inner cavity holds a cleaning material that contains a cleaning agent, which is held in the inner cavity by the seal provided by the substrate. Upon removal, the cap can be placed on a site of a medical implement to clean the site by contact with the cleaning material and cleaning agent.

### CROSS REFERENCE TO RELATED APPLICATIONS

This application claims the benefit of priority under 35 U.S.C. §119 to U.S. Provisional Patent Application Ser. No. 61/444,629, filed on Feb. 18, 2011, entitled, “MEDICAL IMPLEMENT CLEANING SYSTEM”, which is incorporated by reference, herein, in its entirety.

### BACKGROUND

Within the medical field, and in particular the area of infusion of fluids or aspiration of fluids to or from a patient, there is a need to prevent the transmission of pathogens into or onto a patient from a potentially contaminated surface of a medical implement, or “site”. Such pathogens include microorganisms such as bacteria and viruses. The transmission of pathogens into a patient may result in an infection that could be life threatening. Specific to healthcare settings, the term “nosocomial infections” describe those infections that originate or occur in a hospital or hospital-like setting. In the US, nosocomial infections are estimated to occur in 5% of all acute care hospitalizations. The estimated incidence is more than 2 million cases per year, resulting in an added expenditure in excess of $4.5 billion. Nosocomial infections are estimated to more than double the mortality and morbidity risks of any admitted patient, and they probably result in about 90,000 deaths a year in the United States. Common sites for such transmissions are found on such medical implements as a luer port, vial, needle free valve, or an injection port of a vessel, tubing, or catheter. Even non-intrusive medical implements such as stethoscopes can transmit pathogens to a patient. The incidence of infection in patients is presently numerous and increasing, and Infection Control Practitioners (ICP's) often cite improper cleaning of sites as a major source of these infections.

Traditionally, cleaning a potentially contaminated surface includes a protocol of alcohol swabbing prior to making the necessary connections to the site. Today alcohol swabs, a small pad of cotton gauze soaked in isopropyl alcohol, are packed individually in a foil package. The foil package is relatively inexpensive, and is used to retain the alcohol within the package and to prevent evaporation. Properly used, the package is opened at or near the site to be swabbed. With gloved hands, the pad is removed by a healthcare provider and wiped across the top and side surfaces of the site, and the pad and foil package are discarded. The site should be allowed to dry, usually twenty to thirty seconds, immediately prior to making any connection. This “drying” period is important: when alcohol dries, it breaks open the cellular walls of microorganisms, thereby killing them.

Unfortunately, because of increased duties and responsibilities, shrinking nursing staffs, and inadequate training, swabbing is often overlooked or is poorly executed. A poorly swabbed site can carry microorganisms that, if allowed to enter a patient's body, can cause serious infection. In addition, supervisory oversight is nearly impossible, because unless a supervisor can actually observe the swabbing being performed, the supervisor cannot know whether or not it was done properly or performed at all. Further, without at least a sufficient microscopic examination for microbial residue, there may be no evidence of an alcohol swab being performed. Thus, a need exists for an apparatus and technique for cleaning a site on a medical implement prior to contact with a patient, and which will eliminate technique-related issues and training issues, and provide an unequivocal indicator that a site is clean prior to accessing a patient's vascular system.

Another problem is that conventional cleaning devices are typically provided in single units, or packaged individually for one-at-a-time use. Such provisioning wastes material and resources, and makes use of the cleaning devices difficult, particularly in situations where multiple cleaning devices can be used in a short timeframe. Accordingly, what is needed is a system that can address the above problems and shortcomings, while making cleaning devices accessible and available for use in multiple numbers.

### SUMMARY

This document presents a cleaning system for cleaning a site of medical implements. The cleaning system includes a flexible elongated strip. The strip is formed of a substrate and an adhesive layer on the substrate. The system further includes a number of cleaning caps that are removably attached to the substrate by the adhesive layer. Each of the cleaning caps includes an inner cavity and an opening to receive a site of a medical implement into the inner cavity, and a cleaning material in the inner cavity adapted to provide radial compression against the site of the medical implement. The cleaning material contains a cleaning agent prior to receipt of the site of the medical implement, which contacts the site upon the radial compression of the cleaning material. In some implementations, one or more caps can include a threaded ring connected to the inner cavity at the opening to the cap, the threaded ring having threads that correspond to threads on a particular medical implement.

The details of one or more implementations are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a perspective view of a cleaning device.

FIG. 2 is a cross-sectional view of an assembled cleaning device.

FIG. 3 is a perspective view of another cleaning device.

FIG. 4 is a cross section of a cleaning device.

FIGS. 5 and 6 show a cleaning device being used to clean a site of a medical implement.

FIG. 7 is a perspective view of a ring that attaches to a corresponding structure of a medical implement.

FIG. 8 is a cross sectional view of another alternative implementation of a cleaning device.

FIG. 9 is a cross-sectional view of an implementation of a cleaning cap.

FIG. 10 is a perspective view of the cleaning cap shown in FIG. 9.

FIG. 11 is a perspective view of cleaning system of a number of cleaning caps connected to a protective strip, in which each cap can be individually peeled away from the protective strip for use.

FIG. 12 is a bottom perspective view of the cleaning system.

FIG. 13 is a side perspective view of the cleaning system.

FIG. 14 illustrates a cleaning system having a cleaning cap container and dispenser.

FIGS. 15-18 illustrate various implementations of a cleaning system with a planar substrate on which a number of caps are attached, typically in a pattern or array.

FIGS. 19-20 illustrate a planer substrate shape that can be formed to a three-dimensional object with planar sides for making a number of cleaning caps accessible.

Like reference symbols in the various drawings indicate like elements.

### DETAILED DESCRIPTION

This document describes a cleaning system for medical implements. The system includes a number of cleaning caps attached to a substrate. Each cleaning cap can be selectively and individually removed from the substrate, which, prior to such removal, acts as a seal to the opening of each cap. Each cap includes an inner cavity accessible through the opening. The inner cavity holds a cleaning material that contains a cleaning agent, which is held in the inner cavity by the seal provided by the substrate. Upon removal, the cap can be placed on a site of a medical implement to clean the site by contact with the cleaning material and cleaning agent. Similar suitable caps are disclosed in the following applications, the contents of which are hereby incorporated by reference for all purposes: U.S. patent application Ser. No. 12/791,809, entitled MEDICAL IMPLEMENT CLEANING DEVICE WITH FRICTION-BASED FITTING, filed Jun. 1, 2010; U.S. Provisional Patent Application No. 61/318,249, entitled MEDICAL IMPLEMENT CLEANING DEVICE WITH FRICTION-BASED FITTING AND ENERGY DIRECTOR, filed Mar. 26, 2010; and U.S. Provisional Patent Application No. 61/330,243, entitled FEMALE LEUR DISINFECTING CAP, filed Apr. 30, 2010.

In accordance with preferred implementations, a cleaning system includes a cap having a shape and/or external features to promote easy gripping and a cleaning material in the cap that holds or is in contact with a cleaning agent, such as isopropyl alcohol, for application of the cleaning agent to a site of a medical implement. Each cap can be individually gripped and peeled from the substrate, and then applied or positioned on a site of a medical implement, either by screwing onto a threaded site, or by merely placing the cap onto the site. In the latter mode, a user can twist the cap for additional scrubbing of the site with the cleaning material if desired.

The cleaning material in each cap can be any substance that can conform, mold or compress in a manner that enables the effective wiping of the site, including the top surface of the site, side surface, and any threads or grooves, if present, and provide the cleaning agent at least at a surface level. Examples of the cleaning material include cotton, open or closed cell foam such as polyethylene foam, or other substance that can hold or carry the cleaning agent. The cleaning agent can be any chemical, substance or material that cleans the site of bacterial or even viral microorganisms, or any carrier that contains such chemical, substance or material. Examples of a cleaning agent include isopropyl alcohol, chlorhexidine, povidone-iodine, hydrogen peroxide, soap, and hydrochloric acid.

The term “medical implement” is used to denote any tool or object that can be used in a medical setting and that can connect to a site cleaning device as described herein according to a number of implementations. Examples of medical implements include, but are not limited to, access ports on tubing sets (extension sets, T-connectors and IV sets), access ports on catheters (both peripheral and central lines), needle free valves, stopcocks, luer connectors, stethoscopes and other components or devices whereby regular cleaning is desired. Medical implements are often commercially available in standard sizes. Thus, the end or opening of a cleaning device for a site of a medical implement can be provided with fittings to accommodate such standard sizes, or can be specially sized and adapted for non-standard sizes.

The cap of the cleaning device is made of a material that is compatible with the cleaning materials and agents to be used, examples of materials would include, sealed foam, plastic, glass, or metal. The cleaning device may undergo prior sterilization. For securing the cleaning device to another device, the cleaning device can include attachment mechanisms such as “snap-fit” mechanisms or clamps to hold it in place on the other device. Alternatively the cleaning material in the cap may conform to the sides of the medical implement to thereby “grip” and remain secured to the medical implement. The cap also may have threading to secure it in place on a medical implement. The cap may have some cutaway portions on its walls to enable the use of some undercuts during the molding process, and to allow the cleaning material to flex outward both during use. The cap can be made from polyethylene or another material that is stable when in the presence of alcohol or other cleaning agent.

In preferred exemplary implementations, prior to being applied to a site, and after the cleaning material is provided with a cleaning agent, the opening of the cap is sealed with a foil-based seal or other material suitable for retaining a cleaning agent in the cleaning material and preventing evaporation of the cleaning agent. The cap seal may also be formed in a manner whereby several caps could be attached i.e. a strip, where individual caps can be peeled from the strip in order to be used. These strips of caps can be hung from I.V. poles, I.V. sets, in patient rooms and medication carts, to name just a few of the possibilities. The strips provide the convenience of having several caps available in one location.

The cleaning material in the cap can be an alcohol-soaked piece of gauze, foam or similar cleaning material. The cleaning material can be formed into the general interior shape of the cap from one or more pieces, or formed of a shape such as a cube and inserted at least partly compressed into the inner cavity of the cap. For instance, the cleaning material can include a ring for circumscriptive coverage and cleaning of the site, and further include a cylinder within the ring for coverage and cleaning on a distal end of the site. A single piece of cleaning material may also be cut or formed to perform the same coverage and cleaning functions as the two pieces described above. The cleaning material may also cover the threads and/or be formed as part of the threads.

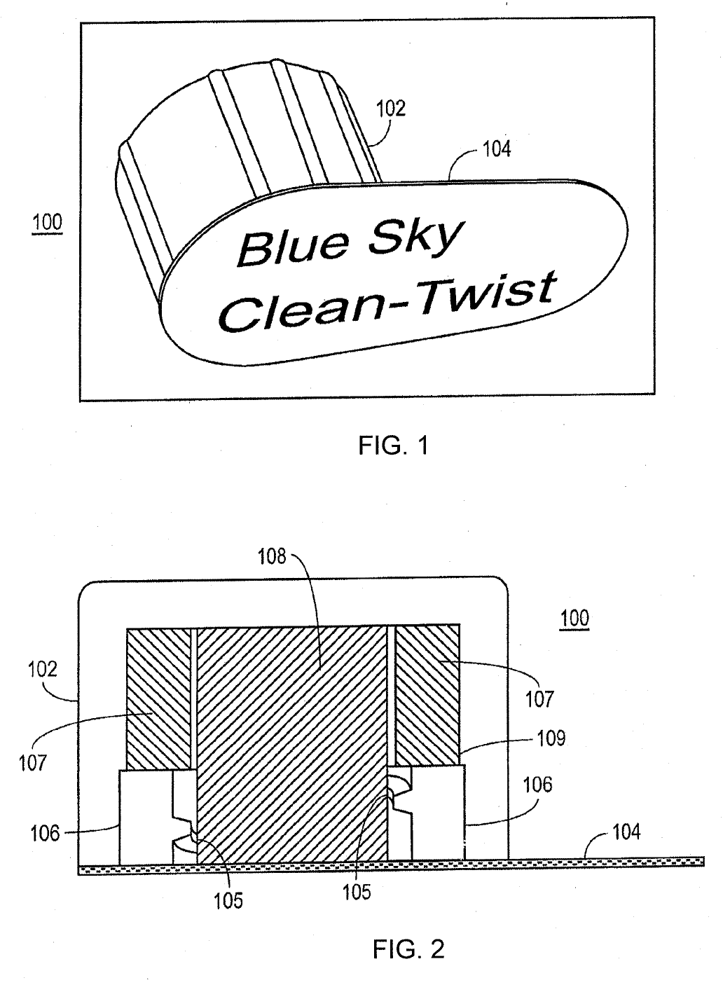

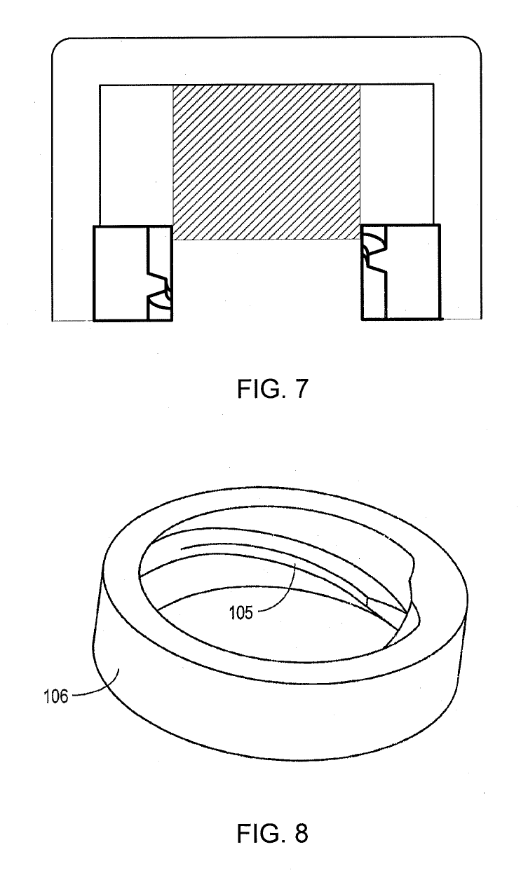

FIGS. 1-6 illustrate a cleaning device 100, also referred to herein simply as a “cap”. FIG. 1 is a perspective view of the cleaning device 100 formed of a cap 102 with a seal 104 that is connected to and covers the opening of the cap 102. As will be described below, the seal 104 can be a planar substrate to seal a number of caps 102 in a variety of alignments and configurations. The cap 102 can have a number of gripping ridges or projecting members for ease of use. FIG. 6 is a cross-sectional view of the cleaning device 100. The cap 102 forms an inner cavity with one opening that is large enough to receive a site of a medical implement. The seal 104 is affixed to the opening and is preferably entirely removable. In other implementations, the seal 104 is permanently affixed, and is simply punctured by insertion of a site of a medical implement.

The cap 102 houses a threaded ring 106 proximate to the opening. The threaded ring 106 includes one or more threads 105 and is adapted to receive the site of the medical implement to be disinfected, and thus defines the size and shape of the opening. This embodiment is advantageous because it creates a single circumferential seal point, seal 104 to the opening of cap 102.

In some implementations, the cap 102 and threaded ring 106 are formed of a unitary piece of material. In other implementations, the threaded ring 106 fits into a groove 109 that is formed in the inside edge surface of the cap 102 near the opening. In this latter configuration, the groove 109 maintains the position of threaded ring 106 near the open end of the cap where the threaded ring top surface may be flush with or slightly recessed from the cap open end walls, and the threaded ring 106 may also include or create with the cap wall a small vent aperture or opening to allow evaporation of a cleaning agent in the cap 102. The threaded ring 106 can be mechanically kept from rotating with internal ribs or protrusions in cap 102 or groove 109. Threaded ring 106 may be held in place within grove 109 and cap 102 by glue, welding, snap-fit, solvent bonding or any other mechanism or composition.

The cleaning device 100 further includes a first cleaning material 107 that holds the cleaning agent, such as isopropyl alcohol, and a second cleaning material 108 that also holds or is at least partially saturated by the cleaning agent. In preferred exemplary implementations, the first cleaning material 107 is formed as a hollow cylinder or ring positioned between the threaded ring 106 and the top inside surface of the cap 102, and is adapted for radial compression against a site that is inserted into the cap 102 or over which the cap 102 is placed. In some implementations, the second cleaning material 108 is formed as a solid cylinder and positioned within the hollow space of the first cleaning material 107, and is adapted for axial compression against a leading edge of the site that is inserted into the cap 102 or over which the cap 102 is placed. In other implementations, cleaning materials 107 and 108 can be made of a single piece of material and cut or formed so as to achieve the same result as described above. The cleaning agent is provided to the cleaning materials 107, 108 prior to the opening being covered with the seal 104.

In some implementations, the cleaning device 100 includes one piece of compressible cleaning material that is pre-loaded or at least partially saturated with a cleaning agent, prior to the cap 102 being sealed by a removable seal, or being attached and sealed to an elongated strip. Removal of the seal from an opening of the cap 102, or removal of the cap 102 from a strip, provides a cap 102 that is adapted for use on a site of a medical implement, and for venting the inner cavity of the cap, including eventual evaporation or venting of the cleaning agent. Accordingly, each cap 102 is adapted for single use, unless the cap 102 is sterilized, re-loaded with cleaning agent, and then re-sealed.

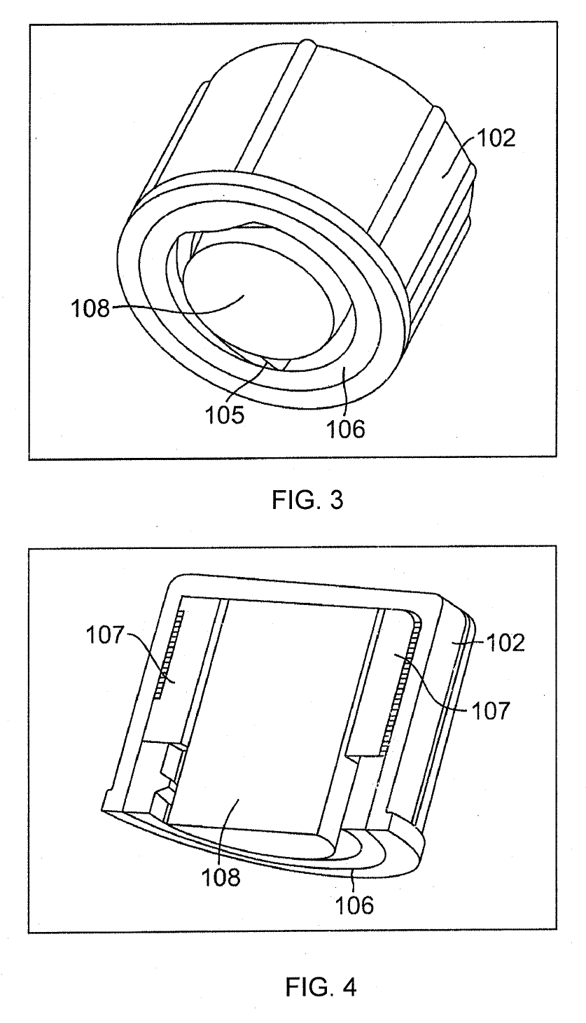

FIG. 3 is a bottom perspective view and FIG. 4 is a cross-sectional view of the cleaning device 100 with the seal 104 removed, showing the cap 102, threaded ring 106 that sits within the cap 102, and the second cleaning material 108 inside the cap 102. The second cleaning material 108 can extend to and slightly beyond the opening of the cap 102. FIG. 4 further shows the first cleaning material 107 that circumscribes the second cleaning material 108 and being positioned between the threaded ring 106 and the top inner surface of the cap 102.

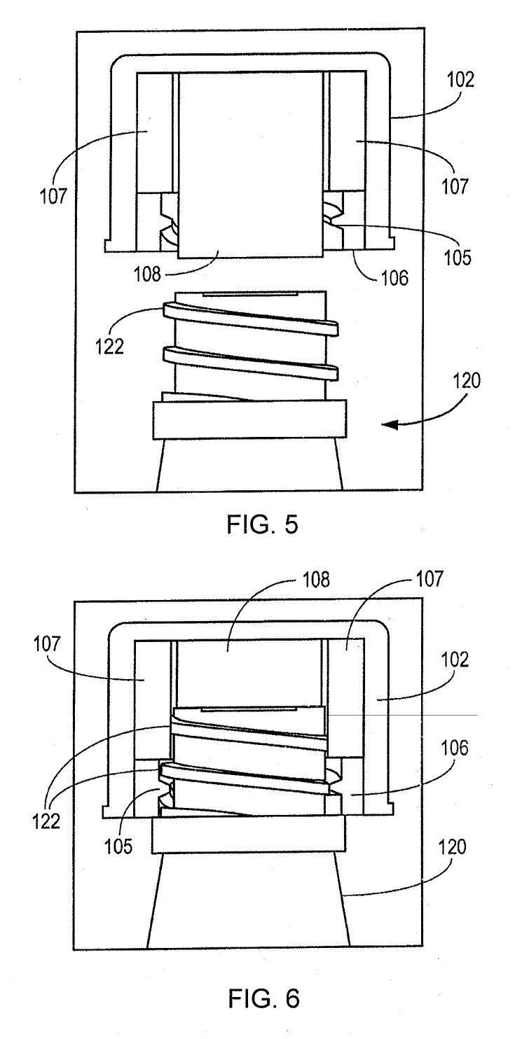

FIG. 5 illustrates the cleaning device 100 about to make contact with a site 120 of a medical implement. As discussed above, the site 120 can be a luer port, a, a needle free valve, an injection port of a vessel, or other medical implement that needs to be cleaned prior to use with a patient. In some implementations, the site 120 can include a set of threads 122 that correspond to the threads 105 in the threaded ring 106 of the cleaning device 100. The cleaning materials 107 and 108 are preloaded with a cleaning agent, before removal of the seal and contact by the site 120. Accordingly, as shown in FIG. 6, the site 120 makes contact with the cap 102 by a screwing motion relative to the cap 102. The second cleaning material 108 is compressed axially and swabs against the leading edge of the site 120, while the first cleaning material 107 is compressed radially and swabs against sides of the site 120.

FIG. 7 shows a cross-section of a cap that includes an opening to an inner cavity. The opening has a slight ridge to form a ring receptacle, into which a threaded ring can be positioned and mated at the opening of the cap. The cap includes a single piece of cleaning material having a cleaning solution. In preferred implementations, the cleaning material is foam, and the cleaning solution can be one or more of isopropyl alcohol, ethyl alcohol, CHG, choloroxylenol (PCMX), providone iodine, etc. The cleaning solution can also include emollients or other components. In other implementations, the cleaning material and cleaning solution can be formed of a thixotropic substance such as a gel or foam, or of a fluid with high viscosity, which may be impregnated with one of the above other cleaning solutions.

FIG. 8 illustrates one example of a threaded ring 106 and its threads 105 that can accomplish a near-universal fit for threaded sites of conventionally-available medical implements such as catheters, injection ports, leur valves or the like. An attribute of the threaded ring 106 shown in FIG. 7 is that there are only two opposing threads that travel 180 degrees before terminating. This enables the molding of threaded ring 106 without the use of a screw to create the thread feature in an injection molding tool. The threaded ring 106 can also be produced with an injection molding tool utilizing a screw. FIG. 7 illustrates the molded threaded ring 106 with two opposing threads 105 that traverse opposing 180 degree portions of the ring. This implementation also allows the threads of a site of a medical implement to be when the cap 102 (into which the ring 106 is placed) is positioned on the site, because the threads 105 do not cover all of the corresponding threads of the site, which are then bathed in the cleaning agent.

In some implementations, the molded thread ring 106 with two opposing threads 105 traverse opposing 180 degree portions of the ring, to enable the thread ring 106 to be molded without the use of a screw that is typically used to create threaded parts in a molding process. Thus the threaded ring 106 can be manufactured very inexpensively. The threaded ring 106 can also clean some of the threads when the cap is placed into position, and may or may not cover all the threads. In some alternatives, the threaded ring 106 can be molded from the cleaning material, or the cleaning material is formed only of the threaded ring 106. In such implementations, the cleaning can occur on threads of the site and in an axial direction by the threaded ring 106.

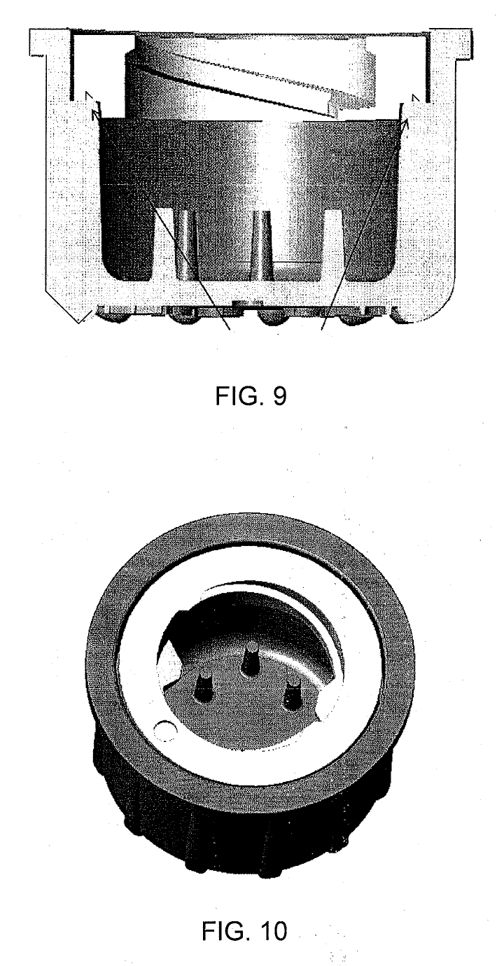

FIG. 9 shows a cross-sectional view of another implementation of a cap with a threaded ring mated thereon within a ring receptacle portion of the inner surface at the opening of the cap. A bottom of the ring receptacle portion can include one or more energy directors for receiving the threaded ring. The energy directors can be melted down as the threaded ring is ultrasonically welded into place in the ring receptacle. In some implementations, the threaded ring can be formed with coincident holes or channels for receiving and connecting with the energy directors. Further welding or bonding of the threaded ring can occur as the energy directors are melted down, either by thermal bonding or ultrasonic welding.

FIG. 10 is a top perspective view of a cleaning cap with a threaded ring attached to a cap at a ring receptacle formed in the cap. The threaded ring may be attached to fit entirely within the ring receptacle, such that no gaps or apertures are left between the outside of the threaded ring and the inside surface of the opening to the inner cavity of the cap. Alternatively, the threaded ring may allow a slight gap or even a defined hole, aperture or vent at the interface with the cap inside surface, to allow aspiration or evaporation of any cleaning solution being held in the inner cavity of the cap. In a specific implementation, evaporation rates of the cleaning solution can be controlled by providing a specific-sized hole, aperture or vent, such that a time-related volume of evaporation can be determined to occur.

The hole, aperture or vent can be formed upon receipt of a site of the medical implement, i.e. be contiguous with the opening into the inner cavity of the cap. Or, the hole, aperture or vent can be separate from the opening into the inner cavity, which opening receives the site of the medical implement. In still other implementations, the hole, aperture or opening can be formed by a vertical gap in the threads, or by the channel formed between the threads (i.e. a predetermined extra allowance or tolerance formed in the threads).

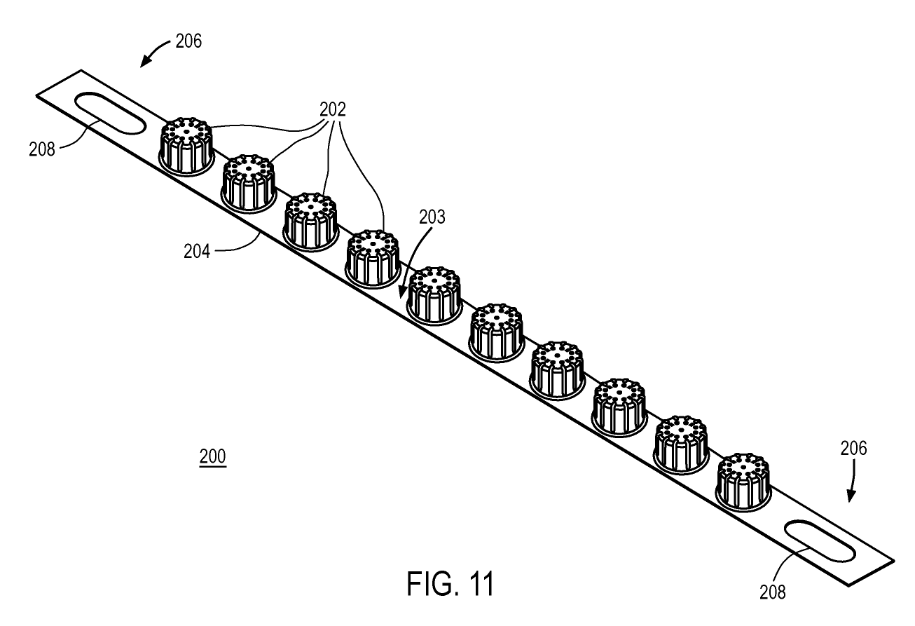

FIG. 11 illustrates a cleaning system 200 in which multiple caps 202 are adhered, bonded, attached, or otherwise connected with a foil 204 that seals the opening to each of the caps 202. In the implementation shown in FIG. 8, the foil 204 is in the form of an elongated strip that is wider than the opening of a cap 202 to completely seal the opening of the cap 202 with clearance, and has a length that will accommodate a number of caps 202 connected substantially in a line along the length. In one example, each elongated strip can accommodate ten to twelve caps 202.

In preferred implementations, the foil 204 is formed of a substantially flexible but resilient substrate having an adhesive side 203 with an adhesive layer that is activated by heat and/or pressure to adhere to the outer perimeter of the opening of each cap 202. In some implementations, a number of heated heads are used in a manufacturing process, where the heads are heated to 350 to 400 degrees or more, and contact the foil 204 on a side opposite the adhesive side at a pressure between 20 and 100 psi, and preferably about 60 psi. In one particular implementation, the foil 204 is positioned on top of a number of caps 202, such as ten caps 202 in a linear arrangement, and the heat and pressure provided to the foil 204 and therefore onto the opening of the caps 202, activates the adhesive on the bottom of the foil, which then adheres to each cap 202.

The foil 204 can be made of a thin sheet of pliable metal or metallic material such as aluminum, and coated with the adhesive on the adhesive side. Alternatively, the foil 204 can be rigid or semi-rigid, such as a sheet of plastic. In still other alternatives, the foil 204 can be formed with threaded protrusions (not shown) onto which each cap 202 can be individually screwed and tightened until the opening of the cap 202 is sealed against the adhesive side 203 of the foil 204. The foil 204 and attached caps 202 can be heated to further seal each cap 202 to the foil 204.

As shown in FIG. 11, the foil 204 can be an elongated strip having at least one mounting end 206 for mounting or attaching to another object. In some implementations, the mounting end 206 includes a hole 208 for mounting on a hook or a peg, which in turn is attached to a wall, a patient bed, hospital equipment, or a belt of a care provider. The hole can be any shape of perforation, aperture or the like. In other implementations, the mounting end 206 can include a clip, hook, or other mechanical attachment device to attaching to another object. The elongated strip can include perforations between the caps 202, but in other implementations includes no perforations, cuts, indentations or other separations.

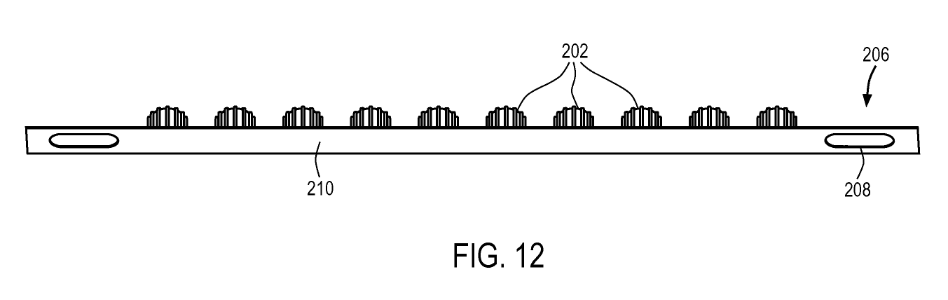

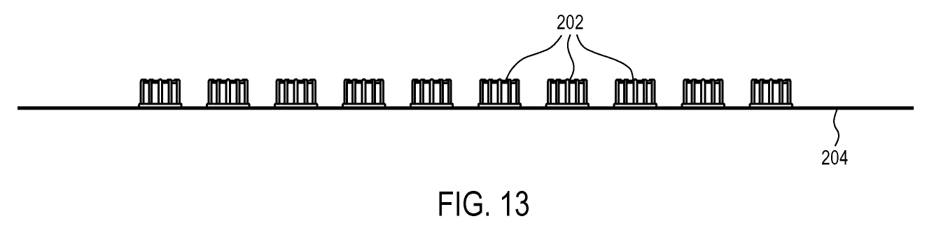

FIG. 12 is a perspective view from the bottom 210 of the cleaning system 200. The bottom 210 is on the opposite side of the foil 204 than the adhesive side 203. The bottom 210 can include labeling and text, such as instructions for use, etc. FIG. 13 is a perspective view of the cleaning system 200 from the side, illustrating the foil 204 as a substrate.

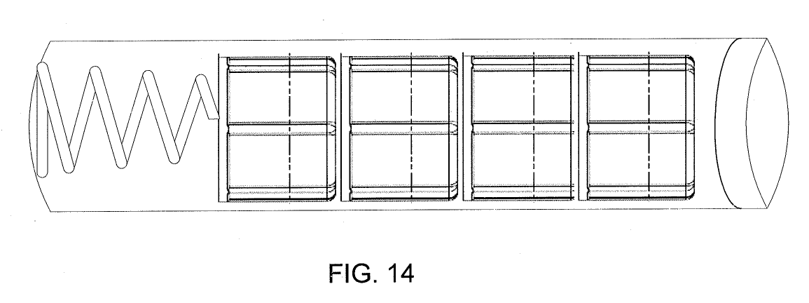

FIG. 14 illustrates yet another implementation of cleaning system. The system includes a chamber, such as a tube or a cylindrical chamber. A number of cleaning caps, as described above, can be inserted into the chamber and spring loaded, via a spring or other biasing mechanism, toward an opening or lid of the chamber. Each cap is individually sealed with a removable foil or seal. The caps can be retrieved one-at-a-time as desired or needed from the opening or lid of the chamber. In some implementations, the chamber can include a button or lever that can be actuated by a user to expel one or more caps. In preferred implementations, the chamber is a rigid tube that can be carried by a user or attached to another object such as a belt, a chair, a table or such. In other implementations, the chamber can be formed of a wrapping such as paper, and simply peeled away to access the caps. In such implementations, the wrapping can be pre-formed with graduated or measured perforations, such that a measured portion of the wrapping can be peeled away to access only one cap.

In still other implementations, a cleaning system can include multiple chambers. The multiple chambers can be of different sizes, diameters or shapes, to contain and dispense associated caps of different sizes or configurations. The multiple chambers may be of different colors as well, to be matched with a particular color of different cap configurations.

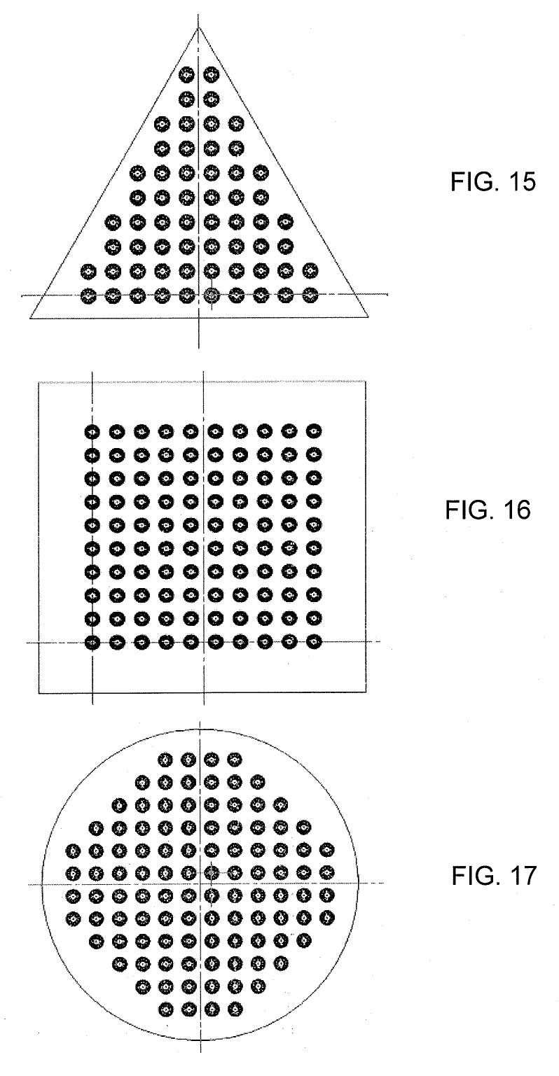

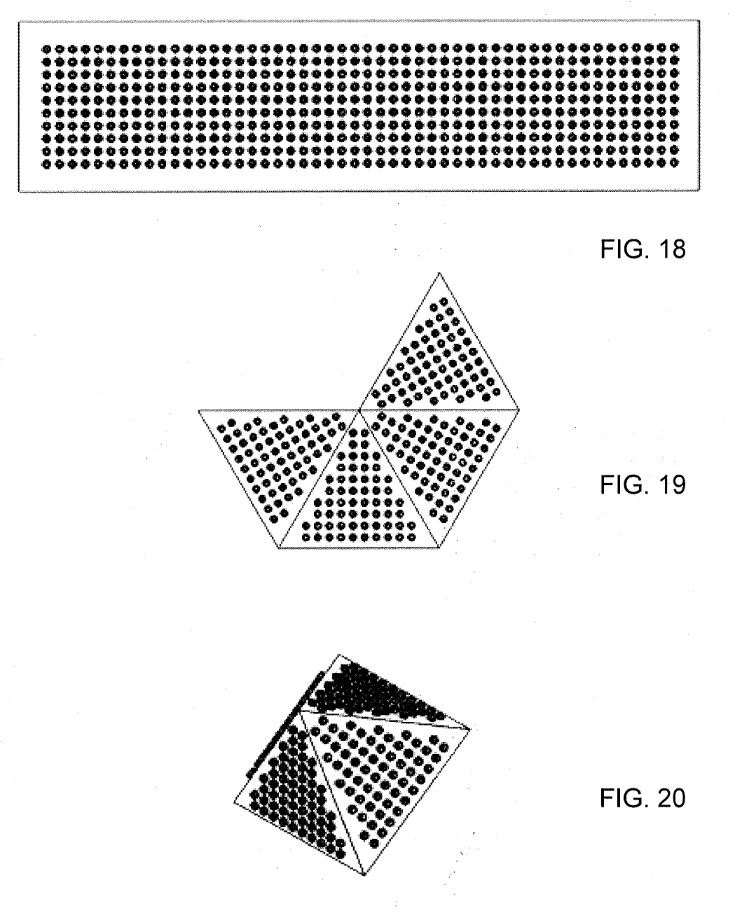

In reference to the cleaning system 200 shown in FIGS. 11-13, a system can include a planar foil or substrate in a variety of forms and shapes, such as a triangle (FIG. 15), square (FIG. 16), circular (FIG. 17) or a parallelogram, trapezoid, or rectangle (FIG. 18). Each of these shapes may have their own advantages as to how the system is mounted for accessibility to the attached caps by a user, or how the system is packaged and distributed. For instance, a particularly shaped substrate or foil that is formed of four triangular subsections, as shown in FIG. 19, can be connected together for form a three-dimensional platform for the caps, as illustrated in FIG. 20. Other shapes, whether two- or three-dimensional, are possible for the cleaning system.

The use of the various implementations and implementations above entails the following: the healthcare worker would, preferably with gloved hands, remove a cap from a foil strip to which the cap is attached. The cap includes a cleaning material that is pre-loaded with a cleaning agent, i.e., the cleaning material has been at least partially loaded with a cleaning agent prior to the cap being sealed by, or adhered to the foil strip.

The removed cap is placed over or on the site of a medical implement to be cleaned. Upon placement, the cleaning agent-soaked cleaning material wipes all of the port's surfaces, and the inner cavity of the cap is vented. The venting includes venting and evaporation of the cleaning agent from the cleaning material. The wiping could be accomplished by either a turning motion (if threads are used) or by simply pushing the cap onto the port. In this way the cap eliminates errors in the practice of swabbing due to poor training or excessive workloads. The cap would then remain secured in place, such as by threads, mechanical tension provided by the foam, cotton, etc., snaps or some other mechanism.

A cap in place on a medical implement is a positive indication that a desired site of the medical implement is clean. A vibrant color may be used to allow instant visualization of a cap's presence from a door or hallway. ICP's can review compliance by merely observing sites to see whether or not a cap is in place. The cap could remain in place for periods of up to three days or more. For extended periods the alcohol will likely evaporate, which assures that the site is clean. With the cap in place, it continues to keep the site clean even after the alcohol has evaporated.

Although a few implementations have been described in detail above, other modifications are possible. For instance, any of the implementations described above may be sized and scaled for a particular medical implement, such as a stethoscope. Further, a system can include a variety of caps, such as different sized caps and/or some caps with threaded rings and other caps without threaded rings. Different caps can have different colors representing their type or size. Further, sets of caps can be arranged together on a substrate based on size, type, or other feature. The caps and/or substrate may be printed with text to characterize or describe associated caps.

Other implementations of a cleaning system can include a tray having a number of wells arranged on the tray. A cap filled with cleaning material and cleaning agent can be placed in each of the wells, and the tray can be covered with a foil layer to seal each well. A user can push a cap through a portion of the foil layer above the well to both break the antiseptic seal as well as access the cap for placement on a site of a medical implement. The tray can be formed of plastic or other rigid material, while the wells are a thin layer of plastic or other flexible material. Other implementations may be within the scope of the following claims.

1. A medical implement cleaning system comprising:
a planar substrate; and
a plurality of cleaning devices removably attached to at least one side of the planar substrate, each of the plurality of cleaning devices comprising:
a cap having an opening to an inner cavity to receive a site of a medical implement; and
a compressible cleaning material that contains a cleaning agent prior to receipt of the site of the medical implement, the compressible cleaning material at least partially secured in the inner cavity to swab and clean the site with the cleaning agent when the site of the medical implement is received into the inner cavity of the cap;
each of the plurality of cleaning devices being attached to the planar substrate so as to seal the inner cavity at the opening of the cap.

2. A cleaning system in accordance with claim 1, further comprising threading around a periphery of the inner cavity of each cap.

3. A cleaning system in accordance with claim 1, wherein the substrate includes a flexible base substrate and an adhesive on the at least one side to attach each cap to the flexible base substrate.

4. A cleaning system in accordance with claim 1, wherein the substrate is elongated and includes a hole at least at one end of the elongated substrate.

5. A cleaning system in accordance with claim 1, wherein the substrate is rigid.

6. A cleaning system in accordance with claim 1, wherein the plurality of caps are positioned in a line on a linearly elongated substrate.

7. A cleaning system in accordance with claim 1, wherein at least one of the plurality of caps further includes threading around a periphery of the single inner cavity, the threading including a friction-forming member for creating a friction-based fitting of the cap onto the site of the medical implement.

8. A cleaning system for a threaded medical implement, the cleaning system comprising:
a flexible elongated strip, the strip comprising a substrate and an adhesive on the substrate; and
a plurality of caps removably attached to the substrate by the adhesive, each of the plurality of caps comprising:
an inner cavity and an opening to receive a site of the medical implement into the inner cavity;
a threaded ring connected to the inner cavity at the opening to the cap, and having threads that correspond to threads on the threaded medical implement;
a cleaning material in the inner cavity adapted to provide radial compression against the threaded medical implement, the cleaning material containing a cleaning agent prior to receipt of the site of the medical implement.

9. A medical implement cleaning system comprising:
a foil; and
a plurality of cleaning devices removably attached to at least one side of the foil, each of the plurality of cleaning devices comprising:
a cap having an opening to an inner cavity to receive a site of a medical implement; and
a compressible cleaning material that contains a cleaning agent prior to receipt of the site of the medical implement, the compressible cleaning material at least partially secured in the inner cavity to swab and clean the site with the cleaning agent when the site of the medical implement is received into the inner cavity of the cap;
each of the plurality of cleaning devices being attached to the foil so as to seal the inner cavity at the opening of the cap.

10. The system in accordance with claim 9, wherein the foil includes a flexible substrate and an adhesive layer that attaches each of the plurality of caps to the flexible substrate.

11. A cleaning system for a site of medical implements, the cleaning system comprising:
an elongated strip comprising a substrate and an adhesive layer on the substrate; and
a plurality of caps removably attached to the substrate by the adhesive, each of the plurality of caps comprising:
a housing;
an inner cavity defined by the housing and being accessible by an opening to receive a site of a medical implement into the inner cavity; and
a cleaning material in the inner cavity to provide radial compression against the threaded medical implement, the cleaning material containing a cleaning agent prior to receipt of the site of the medical implement.

12. The cleaning system in accordance with claim 11, wherein the elongated strip is flexible.

13. The cleaning system in accordance with claim 11, wherein the elongated strip includes a hole proximate to at least one end of the elongated strip.

14. The cleaning system in accordance with claim 11, wherein the plurality of caps are removably attached to the substrate in a linear array.

15. The cleaning system in accordance with claim 14, wherein the linear array includes the caps being equally spaced along the substrate.

16. The cleaning system in accordance with claim 11, wherein at least one of the caps includes a threaded ring attached to the housing at the opening.
